(19) United States
(12) Patent Application Publication
(10) Pub. No.: US 2003/0026100 A1
(43) Pub. Date: Feb. 6, 2003

(54) Cold light emitting decoration

(76) Inventor: Chun-Hsien Wang, Shin Tien City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/918,805

(22) Filed: Aug. 1, 2001

(51) Int. Cl. F21V 17/02; F21V 9/16

(52) U.S. Cl. 362/321; 362/320; 362/278; 362/351; 362/311; 362/84; 40/544

(57) ABSTRACT

A cold light emitting decoration includes a front plate made of a pliable plastic material and having a recess formed at a rear side thereof for accommodating a cold light emitting sheet and a driving circuit board therein, and a shutter sealing the cold light emitting sheet and the circuit board in the recess of the front plate. The front plate is provided with a specific design, of which some areas are cut away or kept transparent, so that cold light emitted from the cold light emitting sheet passes through the design via the cutaway or transparent areas to create a colorful and luminescent appearance for the decoration. The cold light emitting decoration provides some extent of flexibility and is therefore suitable for attaching to or sewing in differently shaped articles.

### BACKGROUND OF THE INVENTION

The present invention relates to a cold light emitting decoration, and more particularly to a cold light emitting decoration that includes a cold light emitting sheet embedded in a front plate and is adapted to attach to differently shaped articles.

A conventional cold light emitting decoration frequently used with a badge, name tag and other articles usually includes a front plate, and a compartment attached to a rear side of the front plate for accommodating a cold light emitting sheet, a circuit board, etc. Since the conventional cold light emitting decoration must have a shape corresponding to that of an article to which the decoration is attached, complicate procedures are included in the manufacturing of the conventional cold light emitting decoration, Moreover, since the conventional cold light emitting decoration of a certain size and shape could not be widely used on different articles, it is difficult to massively manufacture the decoration at reduced cost.

### SUMMARY OF THE INVENTION

A primary object of the present invention is to provide an integral cold light emitting decoration that could be conveniently attached to various differently shaped articles and could therefore be massively produced at reduced cost to increase the value of the cold light emitting decoration.

To achieve the above and other objects, the cold light emitting decoration of the present invention mainly includes a front plate made of a pliable plastic material and having a recess formed at a rear side thereof for accommodating a cold light emitting sheet and a driving circuit board therein, and a transparent or opaque shutter sealing the cold light emitting sheet and the circuit board in the recess of the front plate by way of bonding or supersonic welding, so that an integral cold light emitting decoration is formed. The front plate is provided with a specific design, of which some areas are cut away or kept transparent, so that cold light emitted from the cold light emitting sheet passes through the design via the cutaway or transparent areas to show colorful lights.

The cold light emitting decoration of the present invention provides some extent of flexibility and is therefore suitable for attaching to or sewing in differently shaped articles, such as key ring, badge, name tag, carpet, bag, knapsack, etc.

The front plate of the cold light emitting decoration of the present invention may also be provided with a specific design through coloring the front plate, so that some areas of the design is transparent while other areas are opaque, allowing the integral decoration to show different brightness levels.

Since both the front plate and the shutter could be made of a pliable plastic material, the whole cold light emitting decoration of the present invention could be more easily processed for attaching to or sewing in differently shaped articles to enable high-efficient production thereof

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an exploded perspective view of a cold light emitting decoration according to an embodiment of the present invention;

FIG. 2 is an assembled perspective view of FIG. 1;

FIG. 3 is a sectioned side view of FIG. 2; and

FIGS. 4, 5 and 6 are different applications of the cold light emitting decoration of the present invention.

### DETAILED DESCRIPTION OF THE PREFERRED EMBODIMENTS

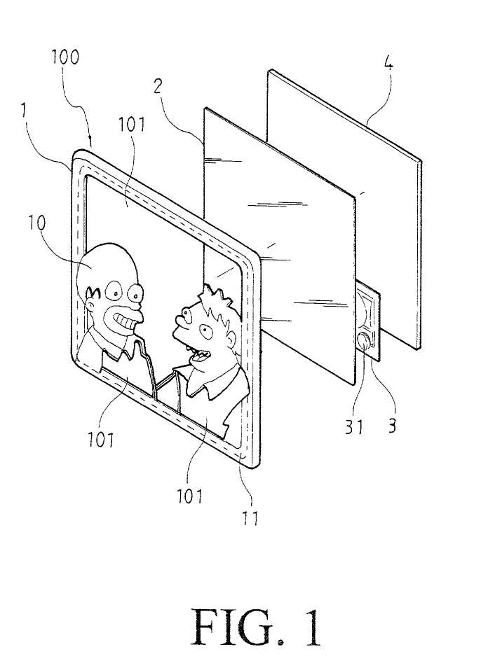

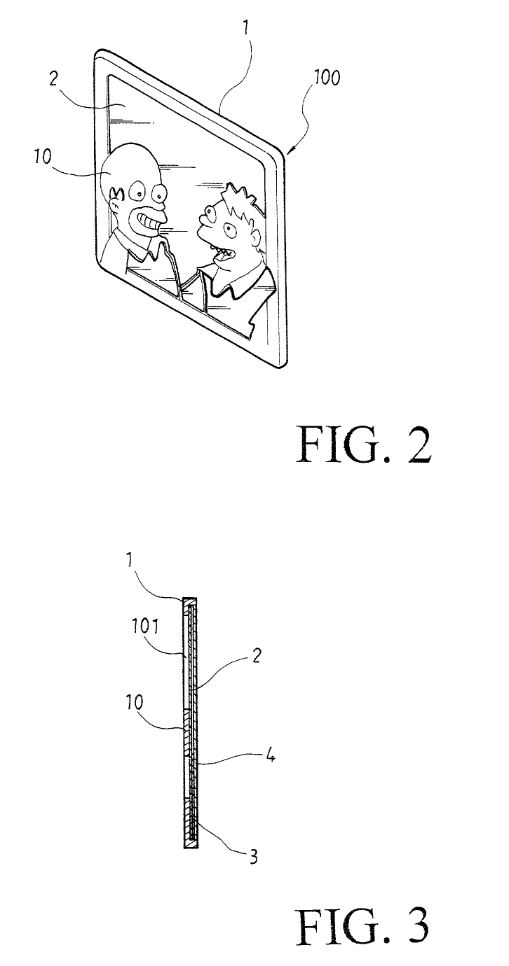

Please refer to FIGS. 1, 2 and 3 at the same time. The present invention relates to a cold light emitting decoration that mainly includes a front plate 1 made of a pliable plastic material. An outer surface of the front plate 1 may be colored, printed or otherwise processed to show a specific design 10. One or more selected areas 101 of the design 10 may be cut away or kept transparent, so that the front plate 1 includes some transparent and some opaque areas to show different brightness levels at different areas. The front plate 1 is provided at a rear side with a recess 11 of a predetermined size for accommodating a cold light emitting sheet 2 and a circuit board 3 therein. The circuit board 3 is electrically connected to the cold light emitting sheet 2 and includes a driving circuit to drive the sheet 2 to emit cold light, and a switch 31 to control power supply to the driving circuit.

After the cold light emitting sheet 2 and the circuit board 3 are positioned in the recess 11 of the front plate 1, a shutter 4 that can be transparent or opaque and has the same size as the front plate 1 is attached to the rear side of the front plate 1 to seal the same by means of, for example, bonding or supersonic welding, so that an integral cold light emitting decoration 100 is formed.

When the switch 31 is actuated, the cold light emitting sheet 2 emits cold light that passes through the cutaway or the transparent areas 101 on the design 10 to create a colorful and luminescent appearance on the decoration 100.

Since both the front plate 1 and the shutter 4 are made of a pliable plastic material, the decoration 100 is suitable for attaching to or sewing in differently shaped articles, enabling the cold light emitting decoration 100 to be more practical for use. For example, the cold light emitting decoration 100 may be used to make a key ring, a badge, a name tag, or be sewed in bag, carpet, knapsack, shoes, etc.

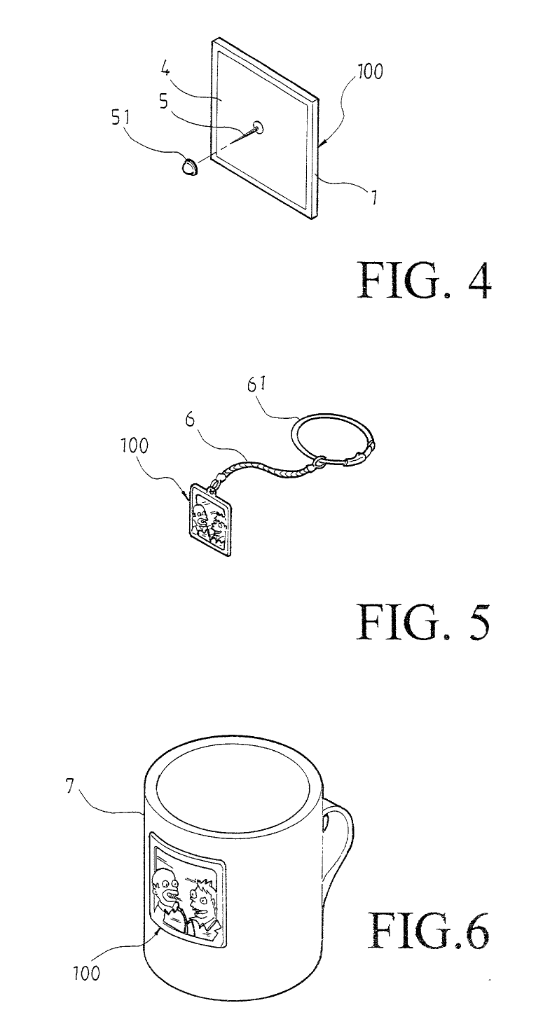

FIG. 4 shows the cold light emitting decoration 100 of the present invention is provided at a back with a pin 5 and a removable fastening cap 51 so as to function like a badge or a brooch for wearing on clothes. FIG. 5 shows the cold light emitting decoration 100 is connected to a ring 61 via a metal chain 6 to provide a key ring.

FIG. 6 shows the cold light emitting decoration 100, which is made of a pliable plastic material as mentioned above and therefore provides some extent of flexibility, is attached to a curved surface, such as an outer surface of a cup 7.

What is claimed is:

1. A cold light emitting decoration comprising a front plate having a recess provided at a rear side thereof for accommodating a cold light emitting sheet and a driving circuit board therein, and a shutter being fixedly connected to the rear side of said front plate to seal said cold light emitting sheet and said circuit board in said recess; and said front plate being provided with a specific design, of which some areas are cut away or kept transparent, so that cold light emitted from said cold light emitting sheet passes through said design via said cutaway or transparent areas.

2. The cold light emitting decoration as claimed in claim 1, wherein said front plate is made of a pliable plastic material and could therefore be attached to or sewed in differently shaped articles.

3. The cold light emitting decoration as claimed in claim 1, wherein said shutter may be made of a transparent or an opaque pliable plastic material or other opaque material.
